(19) United States
(12) Patent Application Publication
(10) Pub. No.: US 2023/0008769 A1
(43) Pub. Date: Jan. 12, 2023

(54) HEAD-UP DISPLAY AND DISPLAY DEVICE

(71) Applicant: Japan Display Inc., Tokyo (JP)

(72) Inventors: Takayuki KATO, Tokyo (JP); Shinichiro TANAKA, Tokyo (JP)

(21) Appl. No.: 17/848,012

(22) Filed: Jun. 23, 2022

(30) Foreign Application Priority Data
Jul. 7, 2021 (JP) JP2021-113129

(51) Int. Cl. G02B 27/01

(52) U.S. Cl. CPC G02B 27/0101

(57) ABSTRACT

According to an aspect, a head-up display includes: a light source configured to emit light; a liquid crystal panel configured to transmit light from the light source to project an image; and an optical member configured to refract light that has passed through the liquid crystal panel. A light output surface of the light source intersects with an optical axis of output light at a first acute angle, the output light having passed through the optical member. A plate surface of the liquid crystal panel intersects with the optical axis of the output light at a second acute angle. The second acute angle is smaller than the first acute angle.

### CROSS-REFERENCE TO RELATED APPLICATION

This application claims the benefit of priority from Japanese Patent Application No. 2021-113129 filed on Jul. 7, 2021, the entire contents of which are incorporated herein by reference.

### BACKGROUND

### 1. Technical Field

What is disclosed herein relates to a head-up display and a display device.

### 2. Description of the Related Art

What is called a head-up display (HUD) that projects an image onto a light-transmitting member such as a windshield to cause a user to view a virtual image, has been known as one of the display devices (for example, Japanese Patent Application Laid-open Publication No. 2007-65011).

It has been known that a stereoscopic effect of a virtual image can be made more remarkable when a light-transmitting liquid crystal panel provided above an optical axis of projected light in the HUD and configured to output an image is inclined with respect to the direction perpendicular to the optical axis. Simple inclination of the liquid crystal panel with respect to the direction perpendicular to the optical axis, however, lowers the luminance of the virtual image. To cope with this, a method for making the stereoscopic effect of the virtual image more remarkable while preventing the luminance of the virtual image from being lowered has been desired.

For the foregoing reasons, there is a need for a head-up display and a display device that can achieve both a stereoscopic effect of a virtual image and securing luminance of the virtual image.

### SUMMARY

According to an aspect of the present disclosure, a head-up display includes: a light source configured to emit light; a liquid crystal panel configured to transmit light from the light source to project an image; and an optical member configured to refract light that has passed through the liquid crystal panel. A light output surface of the light source intersects with an optical axis of output light at a first acute angle, the output light having passed through the optical member. A plate surface of the liquid crystal panel intersects with the optical axis of the output light at a second acute angle. The second acute angle is smaller than the first acute angle.

### BRIEF DESCRIPTION OF THE DRAWINGS

FIG. 1 is a schematic view illustrating an example of the configuration of an HUD according to an embodiment;

FIG. 2 is a schematic view illustrating an example of the configuration of an image output part and an arrangement of a backlight and the image output part;

FIG. 3 is a schematic view illustrating an example of the configuration of an optical member and the traveling direction of light passing through the optical member;

FIG. 4 is a schematic view illustrating a mechanism of change in the traveling direction of light that is caused by the optical member and a protruding portion;

FIG. 5 is a schematic view illustrating an example of the configuration of an optical member and the traveling direction of light passing through the optical member;

FIG. 6 is a schematic view illustrating a mechanism of change in the traveling direction of light that is caused by the optical member and a protruding portion;

FIG. 7 is a schematic view illustrating a mechanism of change in the traveling direction of light that is caused by an optical member and a protruding portion;

FIG. 8 is a schematic view illustrating the configuration in each of Comparative Example 1, Comparative Example 2, and Example; and

FIG. 9 is a view illustrating measurement results obtained by measuring the luminance of light forming a virtual image that is viewed by a user and the contrast of the virtual image in each of Comparative Example 1, Comparative Example 2, and the Example.

### DETAILED DESCRIPTION

Hereinafter, embodiments of the present disclosure will be described with reference to the drawings. What is disclosed herein is merely an example, and it is needless to say that appropriate modifications within the gist of the invention at which those skilled in the art can easily arrive are encompassed in the scope of the present disclosure. In the drawings, widths, thicknesses, shapes, and the like of the components can be schematically illustrated in comparison with actual modes for clearer explanation. They are, however, merely examples and do not limit interpretation of the present disclosure. In the present specification and the drawings, the same reference numerals denote components similar to those described before with reference to the drawing that has already been referred to, and detail explanation thereof can be appropriately omitted.

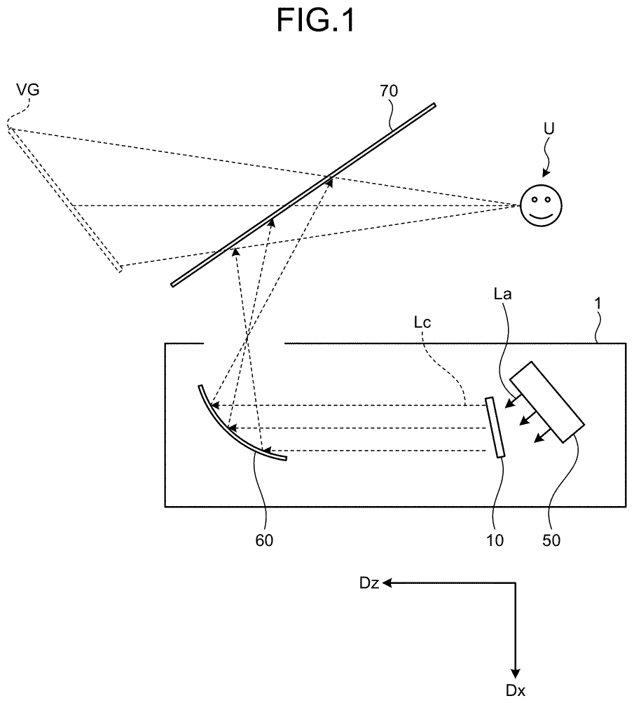

FIG. 1 is a schematic view illustrating an example of the configuration of an HUD 1 according to an embodiment. The HUD 1 includes an image output part 10, a backlight 50, and a concave mirror 60.

The image output part 10 includes a liquid crystal panel 20, which will be described later, and outputs an image utilizing light passing through the image output part 10. The backlight 50 includes a light emitting element such as a light-emitting diode (LED) and functions as a light source configured to emit light from the rear surface side of the image output part 10.

The concave mirror 60 reflects light that has been emitted by the backlight 50 and has passed through the image output part 10 and guides the light to a projection target onto which the image output by the HUD 1 is projected. Hereinafter, an expression of light output from the HUD 1 denotes the above-mentioned light. In FIG. 1, a windshield 70 is illustrated as the projection target. The windshield 70 is, for example, the windshield of a four-wheeled vehicle or the windshield of an aircraft but is not limited thereto. It is sufficient that the projection target has a structure onto which the HUD can project an image and can be appropriately changed.

Light output from the HUD 1 is projected onto the windshield 70. FIG. 1 schematically illustrates light output from the HUD 1 that is projected onto the windshield 70 with dashed arrows. A user U directing his/her line of sight to light projected onto the windshield 70, views a virtual image VG.

In the example illustrated in FIG. 1, only one optical member, as the concave mirror 60, configured to reflect the above-mentioned light is provided on a light traveling route between the image output part 10 and the windshield 70, whereby the image that is output by the image output part 10 is projected onto the windshield 70 in a mirror-reversed state. Thus, when a configuration faithful to FIG. 1 is employed, output of the image output part 10 is controlled in consideration of the mirror reverse. Examples of a method that does not cause the mirror reverse include a method in which another optical member configured to reflect the above-mentioned light is additionally provided on the light traveling route between the image output part 10 and the windshield 70. In the following explanation, it is assumed that no such mirror reverse occurs for the sake of clarity.

As illustrated in FIG. 1, the plate surface of the image output part 10 is inclined with respect to the traveling direction of light Lc from the image output part 10 toward the concave mirror 60. The traveling direction of light La from the backlight 50 toward the image output part 10 intersects with the traveling direction of the light Lc from the image output part 10 toward the concave mirror 60. The output surface of the backlight 50 from which the light La is output is inclined with respect to the traveling direction of the light Lc from the image output part 10 toward the concave mirror 60 at an greater angle than that of the inclination of the plate surface of the image output part 10.

The following describes a relation between each of the traveling directions of the light Lc and the light La and each of the inclination angles of the image output part 10 and the backlight 50. Hereinafter, a direction along the traveling direction of the light Lc is assumed to be an output axis direction Dz as illustrated in FIG. 1. One direction orthogonal to the output axis direction Dz and facing the image output surface of the image output part 10 and the output surface of the backlight 50 from which the light La is output, is assumed to be an orthogonal direction Dx.

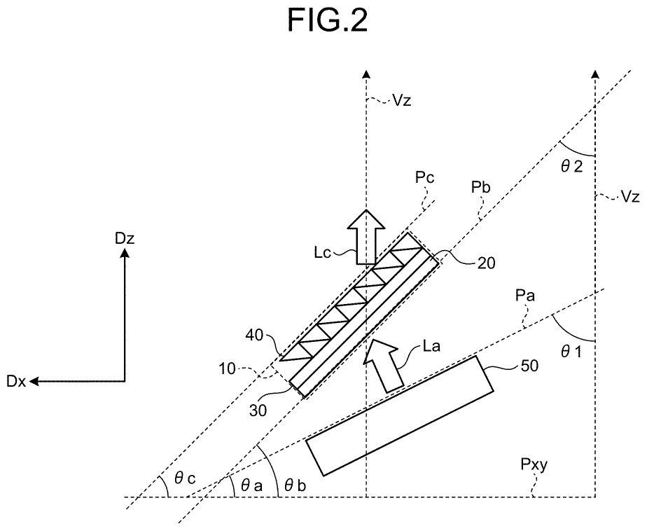

FIG. 2 is a schematic view illustrating an example of the configuration of the image output part 10 and an arrangement of the backlight 50 and the image output part 10. The image output part 10 includes the liquid crystal panel 20, a diffusion plate 30, and an optical member 40. The liquid crystal panel 20, the diffusion plate 30, and the optical member 40 are arranged in the order of the liquid crystal panel 20, the diffusion plate 30, and the optical member 40 from the backlight 50 side to the opposite side thereto (the concave mirror 60 side illustrated in FIG. 1).

The liquid crystal panel 20 is a transmissive liquid crystal display panel. The liquid crystal panel 20 has a plurality of pixels that are driven by an active matrix system. The pixels are arranged two-dimensionally along the plate surface of the liquid crystal panel 20. A region where the pixels are arranged is an image output region. In the image output region, the pixels are individually controlled to form a light transmission pattern corresponding to the image that is projected as the virtual image VG.

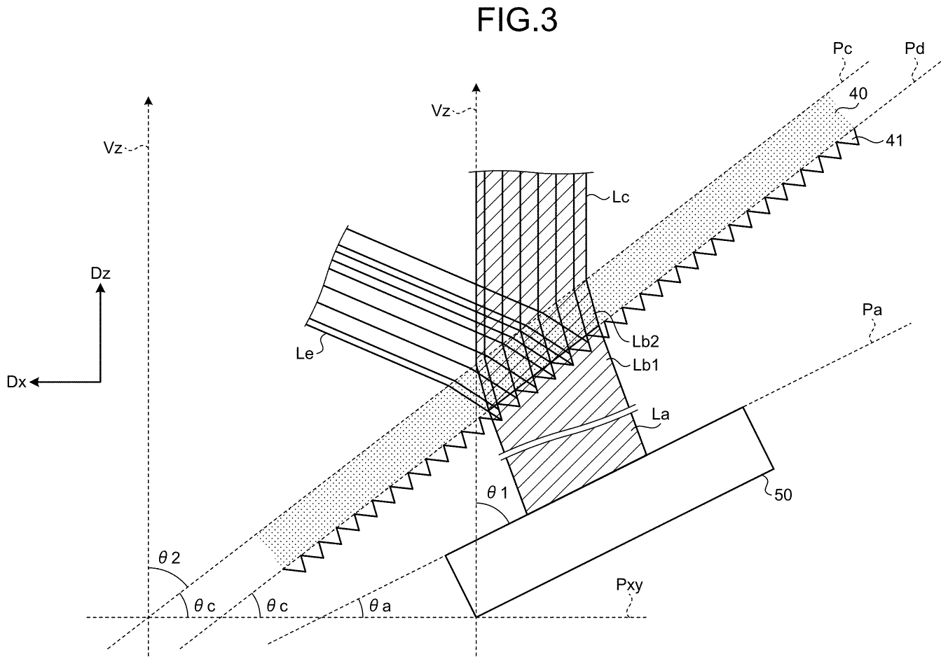

The diffusion plate 30 diffuses and transmits incident light. After the light La emitted from the backlight 50 passes through the liquid crystal panel 20, when light (for example, light Lb1 illustrated in FIG. 3) that has passed through the liquid crystal panel 20 is incident on one surface of the diffusion plate 30, the light that has passed through the liquid crystal panel 20 is diffused by the diffusion plate 30 and passes therethrough toward the optical member 40.

The optical member 40 is an optical element that outputs, as the output light Lc, the incident light La incident on the image output part 10. The output light Lc is along an output axis Vz. The output axis Vz is along the output axis direction Dz. On the other hand, the incident light La travels in a direction intersecting with the output axis Vz. That is to say, the optical member 40 is an optical element that refracts the traveling direction of light that is incident as the incident light La to the traveling direction of light that is output as the output light Lc.

The angles of the image output part 10 and the backlight 50 and the angles of the incident light La and the output light Lc can be defined as angles with respect to the output axis Vz along the output axis direction Dz and angles with respect to a plane Pxy orthogonal to the output axis Vz. For example, the output surface of the backlight 50 through which the incident light La is output is arranged at an angle forming an acute angle θ1 with the output axis Vz. FIG. 2 illustrates that an acute angle formed by a plane Pa and the output axis Vz is the acute angle θ1. The plane Pa is along the output surface of the backlight 50 from which the incident light La is output. The incident surface of the image output part 10 on which the incident light La is incident, that is, the incident surface of the liquid crystal panel 20 on which the incident light La is incident, is arranged at an angle forming an acute angle θ2 with the output axis Vz. FIG. 2 illustrates that an acute angle formed by a plane Pb and the output axis Vz is the acute angle θ2. The plane Pb extends along the incident surface of the liquid crystal panel 20 on which the incident light La is incident.

It can also be regarded that the output surface of the backlight 50 through which the incident light La is output is arranged at an angle forming an acute angle θa with the plane Pxy. FIG. 2 illustrates that an acute angle formed by the plane Pa and the plane Pxy is the acute angle θa. The incident surface of the image output part 10 on which the incident light La is incident, that is, the incident surface of the liquid crystal panel 20 on which the incident light La is incident, is arranged at an angle forming an acute angle θb with the plane Pxy. FIG. 2 illustrates that an acute angle formed by the plane Pb and the plane Pxy is the acute angle θb.

The acute angle θ1 is larger than the acute angle θ2. The acute angle θa is therefore smaller than the acute angle θb. In other words, the gradient angle of the plane Pb with respect to the plane Pxy is larger than the gradient angle of the plane Pa with respect to the plane Pxy.

The output surface of the image output part 10 from which the output light Lc is output, that is, the output surface of the optical member 40 from which the output light Lc is output, is arranged at an angle forming an acute angle θc with the plane Pxy. FIG. 2 illustrates that an acute angle formed by a plane Pc and the plane Pxy is the acute angle θc. The plane Pc is along the output surface of the optical member 40 from which the output light Lc is output. The incident surface of the image output part 10 on which the incident light La is incident, is parallel to the output surface of the image output part 10 from which the output light Lc is output. The acute angle θb and the acute angle θc are therefore equal to each other. One surface and the other surface of each of the plate surfaces of the liquid crystal panel 20 and the diffusion plate 30 are parallel to each other.

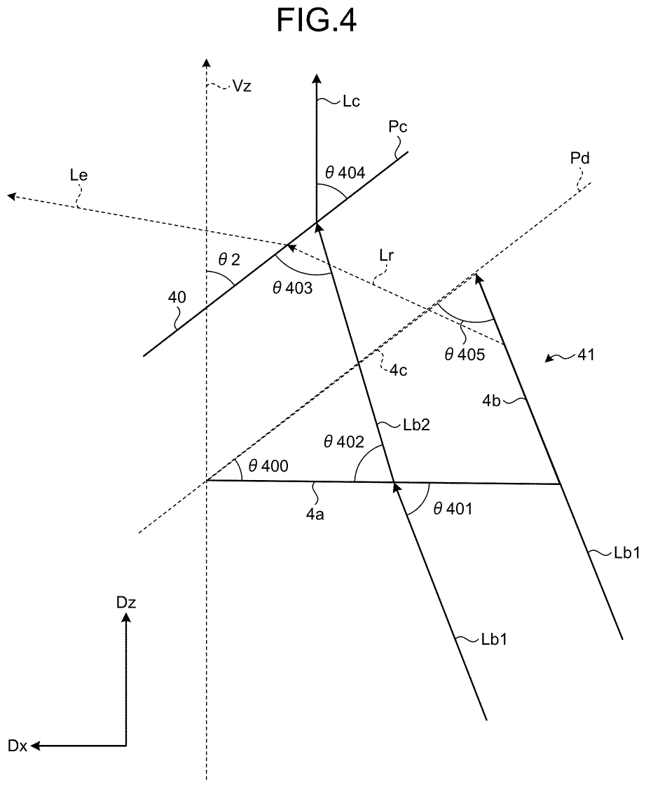

The following explains a mechanism by which the optical member 40 causes the output light Lc output from the image output part 10 to travel along the output axis Vz with reference to FIG. 3 and FIG. 4.

FIG. 3 is a schematic view illustrating an example of the configuration of the optical member 40 and the traveling direction of light passing through the optical member 40. As illustrated in FIG. 3, the optical member 40 has a plurality of protruding portions 41 on the backlight 50 side. Each of the protruding portions 41 has a triangular cross-sectional shape in a viewpoint when a plane along the output axis direction Dz and the orthogonal direction Dx is viewed from the front side. Hereinafter, an expression of cross-sectional viewpoint denotes the viewpoint when the plane along the output axis direction Dz and the orthogonal direction Dx is viewed from the front side.

The bases of the protruding portions 41 having the triangular shapes in the cross-sectional viewpoint coincide with a plane Pd. The plane Pd is parallel to the plane Pc and coincides with the bases of the protruding portions 41. Thus, the plane Pd is a plane with such an angle that the plane Pd forms the acute angle θc with the plane Pxy, like the plane Pc. Although not illustrated in the drawing, the plane Pd is a plane with such an angle that the plane Pd forms the acute angle θ2 with the output axis Vz, like the plane Pc. Although not illustrated in the drawing, a straight line connecting vertices of the protruding portions 41 is parallel to the plane Pc and the plane Pd. The vertices are the vertices of the protruding portions 41 that are located at positions facing the plane Pd.

The protruding portions 41 are aligned with no gap therebetween. It is assumed that a first protruding portion 41 and a second protruding portion 41 denote two adjacent protruding portions 41, and a first vertex and a second vertex denote two vertices of each of the first and second protruding portions 41, which are connected by the base thereof that coincides with the plane Pd. In this case, the first vertex of the first protruding portion 41 coincides with the second vertex of the second protruding portion 41. In other words, the surface along the plane Pd is not exposed to the backlight 50 side of the optical member 40.

The incident light La emitted from the backlight 50 becomes the transmitted light Lb1 and enters the optical member 40 from the protruding portions 41 side. The transmitted light Lb1 is light generated by the incident light La entering the structure (for example, the liquid crystal panel 20 and the diffusion plate 30 illustrated in FIG. 2) of the image output part 10 illustrated in FIG. 2 that is arranged on the backlight 50 side of the optical member 40.

The plate surface of the liquid crystal panel 20 refracts the incident light La. The traveling angles of incident light and output light are substantially the same because both of the plate surfaces of the liquid crystal panel 20 are made of the same material (for example, a glass substrate) and the incident surface of the light La incident on the liquid crystal panel 20 and the output surface of light output from the liquid crystal panel 20 are parallel to each other. As for the diffusion plate 30, the traveling angles of incident light and output light are substantially the same because the incident surface of light and the output surface of the light Lb1 are parallel to each other. The diffusion of light by the diffusion plate 30 is made in order to reduce moire that would be caused by light interference and does not fundamentally change the principal traveling direction of the light Lb1 that is output as the transmitted light Lb1. The traveling direction of the light Lb1 is therefore handled as being the same as that of the incident light La.

A large portion of the transmitted light Lb1 that has entered the optical member 40 from the protruding portion 41 side becomes refracted light Lb2 that is different in the traveling direction from the transmitted light Lb1 due to light refraction caused by the protruding portions 41. The refracted light Lb2 is then output as the output light Lc due to light refraction caused when it is output from the surface of the optical member 40 on the concave mirror 60 side. A portion of the transmitted light Lb1 excluding the large portion thereof is output, as deviating light Le, in a direction different from that of the output light Lc.

FIG. 4 is a schematic view illustrating a mechanism of change in the traveling direction of light that is caused by the optical member 40 and each protruding portion 41. A large portion of the transmitted light Lb1 enters the triangular-shaped protruding portions 41 and the optical member 40 through inclined surfaces 4a of the protruding portions 41. A difference between an acute angle θ401 and an acute angle θ402 depends on a relative refractive index between a material of each of the optical member 40 and the optical member forming the protruding portion 41 and the air outside the optical member 40. The acute angle θ401 is an entering angle of the transmitted light Lb1 with respect to the inclined surface 4a, and the acute angle θ402 is an angle of the traveling direction of the refracted light Lb2, which has entered the protruding portion 41, with respect to the inclined surface 4a.

The optical member 40 and each protruding portion 41 are continuous at a virtual bottom surface 4c of the protruding portion 41 that coincides with the plane Pd, and the virtual bottom surface 4c is therefore not an interface. Each protruding portion 41 is made of the same material as that of the optical member 40. No light refraction therefore occurs at the virtual bottom surface 4c.

As described above, light incident on the optical member 40 as the refracted light Lb2 is output from the optical member 40 as the output light Lc. A difference between an acute angle θ403 and an acute angle θ404 depends on a relative refractive index between the material of each of the optical member 40 and the optical member forming the protruding portion 41 and the air outside the optical member 40. The acute angle θ403 is a traveling angle of the refracted light Lb2 with respect to the surface of the optical member 40 along the plane Pc, and the acute angle θ404 is an angle of the traveling direction of the output light Lc output to the outside of the optical member 40 with respect to the plane Pc. The output light Lc is along the output axis Vz. Thus, the acute angle θ404 as the angle of the output light Lc with respect to the plane Pc is the same as the angle θ2 formed by the plane Pc and the output axis Vz. In other words, the material of each of the optical member 40 and the protruding portion 41 and the acute angle θ403 are determined such that the acute angle θ404 and the angle θ2 are the same. The acute angle θ402 between the refracted light Lb2 and the inclined surface 4a is determined such that the refracted light Lb2 travels at the acute angle θ403 with respect to the plane Pc. It is needless to say that the acute angle θ402 is determined in consideration of a relation between the acute angle θ402 and the acute angle θ401, that is, the relative refractive index between the material of each of the optical member 40 and the optical member forming the protruding portion 41 and the air outside the optical member 40 as well. In other words, an angle of the inclined surface 4a with respect to the output axis Vz and an angle of the plane Pc with respect to the output axis Vz are determined so as to satisfy a relation between the acute angle θ401, the acute angle θ402, the acute angle θ403, and the acute angle θ404, which are illustrated in FIG. 4.

Each protruding portion 41 has a triangular cross-sectional shape and has three surfaces. When one surface 4b different from the inclined surface 4a and the virtual bottom surface 4c among the three surfaces is made along the traveling direction of the transmitted light Lb1 as illustrated in FIG. 4, the transmitted light Lb1 does not enter through the one surface 4b theoretically. That is to say, the transmitted light Lb1 can enter the inclined surface 4a more reliably. On the other hand, the transmitted light Lb1 enters the protruding portion 41 to become the refracted light Lb2, and the traveling direction thereof is changed. A portion of the refracted light Lb2 therefore reaches the one surface 4b in the protruding portion 41 and is reflected, and the traveling direction thereof is changed like reflected light Lr illustrated in FIG. 4. When the reflected light Lr is output from the optical member 40, the traveling direction thereof is further changed. The reflected light Lr is then output as light the traveling direction of which is different from that of the output light Lc like the deviating light Le illustrated in FIG. 3 and FIG. 4.

The deviating light Le does not reach the concave mirror 60 and does not therefore contribute to causing the user U to view the virtual image VG. It is therefore desirable that light like the deviating light Le be less. If an acute angle θ405 of the one surface 4b with respect to the virtual bottom surface 4c and an angle of the refracted light Lb2 with respect to the virtual bottom surface 4c are the same, the refracted light Lb2 does not reach the one surface 4b in the protruding portion 41 theoretically. On the other hand, in this case, the acute angle θ405 is smaller than that illustrated in FIG. 4. A part of the transmitted light Lb1 thereby hits the one surface 4b from the outer side and is reflected or refracted in a direction differing from that of the refracted light Lb2. Not all of the transmitted light Lb1 can therefore be output as the output light Lc by the optical member 40 and the protruding portions 41 explained with reference to FIG. 3 and FIG. 4. In practice, the acute angle θ405 is determined such that light traveling in a direction differing from that of the output light Lc, like the deviating light Le, is minimized.

The acute angle θa=22.27 degrees (°), the acute angle θb=the acute angle θc=45°, the acute angle θ1=67.73°, the acute angle θ2=the acute angle θ404=45°, an acute angle θ400=40°, the acute angle θ401=72.73°, the acute angle θ402=79.49°, the acute angle θ403=60.51°, and the acute angle θ405=63° are examples of the respective angles. The angles are, however, not limited to them and are appropriately changed in accordance with various conditions such as the material forming the optical member 40 and the protruding portions 41.

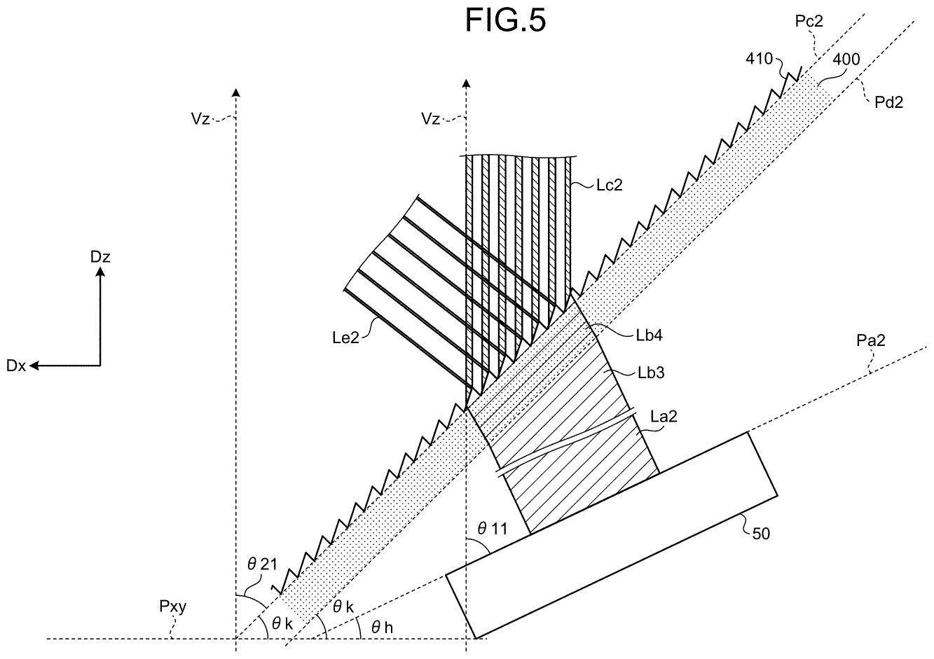

The structures having the triangular cross-sectional shapes, such as the protruding portions 41 on the optical member 40, may be formed on the opposite side, that is, on the concave mirror 60 side (refer to FIG. 1) in the image output part 10. The following explains an example of the configuration when the structures are formed on the concave mirror 60 side in the image output part 10 with reference to FIG. 5.

FIG. 5 is a schematic view illustrating an example of the configuration of an optical member 400 and the traveling direction of light passing through the optical member 400. The optical member 400 illustrated in FIG. 5 differs from the optical member 40 in a specific shape whereas it is similar to the optical member 40 in the functional aspect of changing the traveling direction of light that has entered from the backlight 50 side to form the output light Lc. Thus, the optical member 400 illustrated in FIG. 5 may be provided instead of the optical member 40 illustrated in FIG. 2.

The optical member 400 has a plurality of protruding portions 410 on the side opposite to the backlight 50, that is, on the concave mirror 60 side (refer to FIG. 1). Each of the protruding portions 410 has a triangular cross-sectional shape in the cross-sectional viewpoint.

The bases of the protruding portions 410 having the triangular shapes in the cross-sectional viewpoint coincide with a plane Pc2. The plane Pc2 is parallel to a plane Pd2 and coincides with the bases of the protruding portions 410. The plane Pc2 and the plane Pd2 are planes with such angles that they form an acute angle θk with the plane Pxy. The plane Pd2 extends along the surfaces of the optical member 400 on the backlight 50 side, as illustrated in FIG. 5. The plane Pc2 is a straight line at an angle forming an acute angle θ21 with the output axis Vz. Although not illustrated in the drawing, a straight line connecting vertices of the protruding portions 410 is parallel to the plane Pc2 and the plane Pd2. The vertices are the vertices of the protruding portions 410 on the side facing the plane Pd2.

The protruding portions 410 are aligned with no gap therebetween. It is assumed that a first protruding portion 410 and a second protruding portion 410 denote two adjacent protruding portions 410, and a first vertex and a second vertex denote two vertices of each of the first and second protruding portions 410, which are connected by the base thereof that coincides with the plane Pc2. In this case, the first vertex of the first protruding portion 410 coincides with the second vertex of the second protruding portion 410. In other words, the surface along the plane Pc2 is not exposed to the concave mirror 60 side (refer to FIG. 1) of the optical member 400.

In the example illustrated in FIG. 5, incident light La2 that is different in the traveling direction from the incident light La explained with reference to FIG. 1 to FIG. 4, is emitted. The incident light La and the incident light La2 are along the normal direction of the light output surface of the backlight 50. A plane Pa2 along the output surface of the backlight 50, which is illustrated in FIG. 5, forms an acute angle θh with respect to the plane Pxy, the acute angle θh being different from the acute angle θa illustrated in FIG. 3 and FIG. 4. In other words, the backlight 50 illustrated in FIG. 5 is arranged at such an angle that the plane Pa2 and the plane Pxy form the acute angle θh.

The incident light La2 emitted from the backlight 50 becomes transmitted light Lb3 and enters the optical member 400 from the plane Pd2 side. The transmitted light Lb3 is light generated by the incident light La entering the structure (for example, the liquid crystal panel 20 and the diffusion plate 30 illustrated in FIG. 2) of the image output part 10 illustrated in FIG. 2 that is arranged on the backlight 50 side of the optical member 40. As described above, when the optical member 400 illustrated in FIG. 5 is employed, the optical member 40 illustrated in FIG. 2 is replaced by the optical member 400. Thus, the incident light La2 enters the structure of the image output part 10 that is arranged on the backlight 50 side of the optical member 400, and then becomes the transmitted light Lb3 to enter the optical member 400.

A large portion of the transmitted light Lb3 that has entered the optical member 400 becomes refracted light Lb4 that is different in the traveling direction from the transmitted light Lb3 due to light refraction caused by the optical member 400. The transmitted light Lb4 is then output as output light Lc2 due to light refraction caused when it is output from the protruding portions 410 of the optical member 400 on the concave mirror 60 side. The output light Lc2 is light the traveling direction of which is along the output axis Vz like the output light Lc. A portion of the transmitted light Lb4 excluding the large portion thereof is output, as deviating light Le2, in a direction differing from that of the output light Lc2.

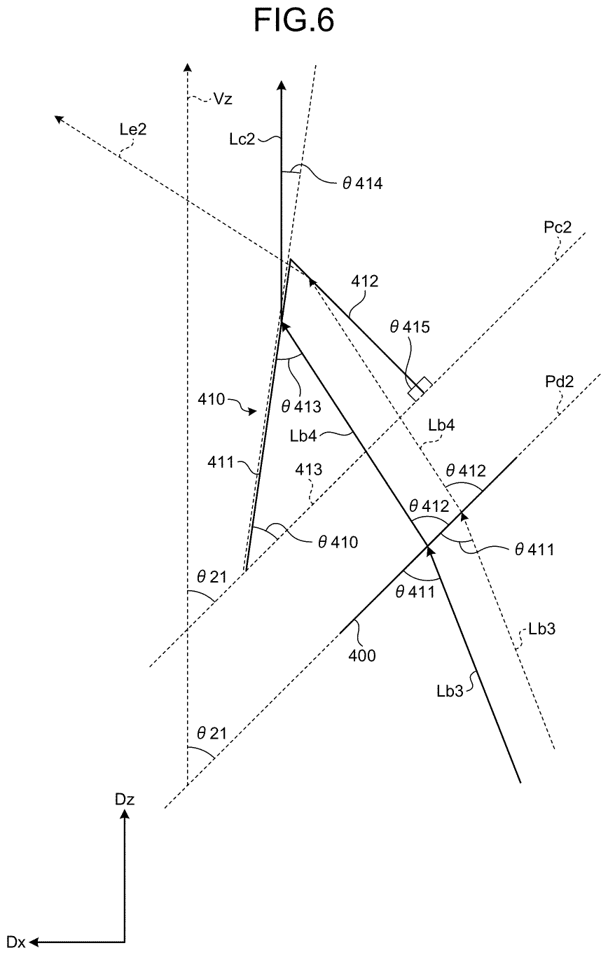

FIG. 6 is a schematic view illustrating a mechanism of change in the traveling direction of light that is caused by the optical member 400 and each protruding portion 410. The transmitted light Lb3 enters the optical member 400 from the plane Pd2 side. A difference between an acute angle θ411 and an acute angle θ412 depends on a relative refractive index between a material of each of the optical member 400 and the optical member forming the protruding portion 410 and the air outside the optical member 400. The acute angle θ411 is an entering angle of the transmitted light Lb3 with respect to the optical member 400, and the acute angle θ412 is an angle of the traveling direction of the refracted light Lb4, which has entered the optical member 400, with respect to the plane Pd2.

The optical member 400 and each protruding portion 410 are continuous at a virtual bottom surface 413 of the protruding portion 410 that coincides with the plane Pc2, and the virtual bottom surface 413 is therefore not an interface. Each protruding portion 410 is made of the same material as that of the optical member 400. No light refraction therefore occurs at the virtual bottom surface 413.

The refracted light Lb4 that has passed through the optical member 400 and the triangular-shaped protruding portion 410 is output from an inclined surface 411 of the protruding portion 410 to the outside of the protruding portion 410, thereby being output as the output light Lc2. A difference between an acute angle θ413 and an acute angle θ414 depends on a relative refractive index between the material of each of the optical member 400 and the optical member forming the protruding portion 410 and the air outside the optical member 400. The acute angle θ413 is a traveling angle of the refracted light Lb4 with respect to the inclined surface 411, and the acute angle θ414 is an angle of the traveling direction of the output light Lc2 output to the outside of the protruding portion 410 with respect to the inclined surface 411.

As described above, the output light Lc2 is along the output axis Vz. Thus, an angle obtained by adding an angle θ410 and the acute angle θ414 together is the same as the acute angle θ21 formed by the plane Pc2 and the output axis Vz. The angle θ410 is an angle formed by the inclined surface 411 and the plane Pc2, and the acute angle θ414 is an angle of the output light Lc2 with respect to the inclined surface 411. In other words, the material of each of the optical member 400 and the optical member forming the protruding portion 410 and the acute angle θ410 are determined such that the angle obtained by adding the angle θ410, which is formed by the inclined surface 411 and the plane Pc2, and the acute angle θ414 together is the same as the angle θ21. The acute angle θ412 between the refracted light Lb4 and the plane Pd2 is determined such that the refracted light Lb4 travels at the acute angle θ413 with respect to the inclined surface 411. It is needless to say that the acute angle θ412 is determined in consideration of a relation between the acute angle θ412 and the acute angle θ411, that is, the relative refractive index between the material of each of the optical member 400 and the optical member forming the protruding portion 410 and the air outside the optical member 400. In other words, the angle of the inclined surface 411 with respect to the output axis Vz and the angle of the plane Pd2 with respect to the output axis Vz are determined so as to satisfy a relation between the acute angle θ411, the acute angle θ412, the acute angle θ413, and the acute angle θ414, which are illustrated in FIG. 6.

The acute angle θh=24.87°, the acute angle θk=45°, an acute angle θ11=65.13°, the acute angle θ21=45°, the acute angle θ410=26°, the acute angle θ411=69.87°, the acute angle θ412=76.63°, the acute angle θ413=50.63°, the acute angle θ414=19°, and an angle θ415=90° are examples of the respective angles. The angles are, however, not limited to them and are appropriately changed in accordance with various conditions such as the material forming the optical member 400 and the protruding portions 410.

Each protruding portion 410 has a triangular shape and has three surfaces. Even when one surface 412 different from the inclined surface 411 and the virtual bottom surface 413 among the three surfaces is set at the right angle θ415 with respect to the plane Pc2 as illustrated in FIG. 6, a part of the refracted light Lb4 reaches the one surface 412 and is reflected by the inner surface of the one surface 412, resulting in change in the traveling direction like the deviating light Le2. The deviating light Le2 does not reach the concave mirror 60 and does not therefore contribute to causing the user U to view the virtual image VG. It is therefore desirable that light like the deviating light Le2 be less. When an internal angle of each protruding portion 410 that is formed by the one surface 412 and the plane Pc2 is smaller than the right angle, light that becomes the deviating light Le2 in the refracted light Lb4 is further increased.

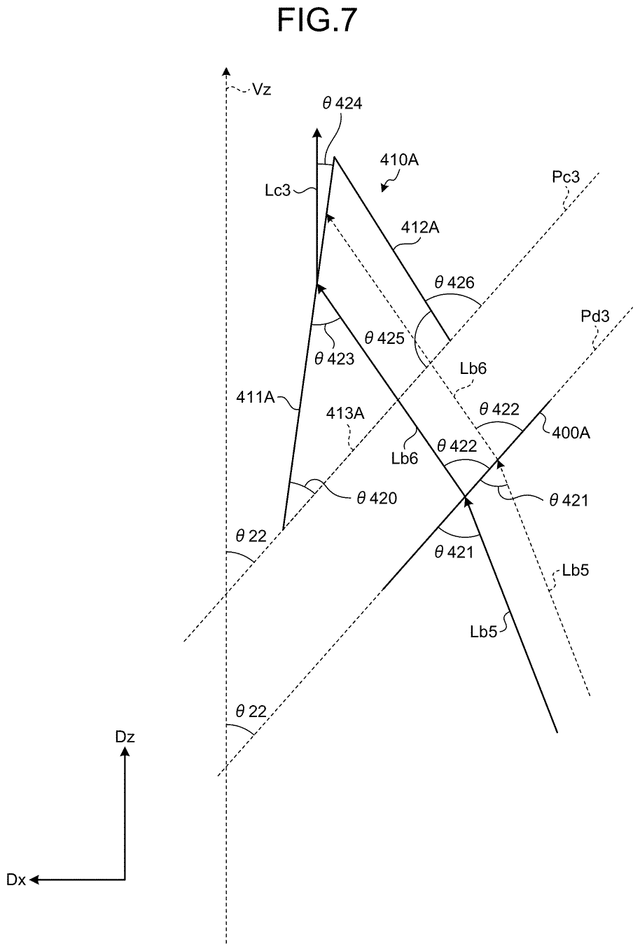

The deviating light Le2 can therefore be prevented from being generated by setting the internal angle of the protruding portion 410 that is formed by the one surface 412 and the plane Pc2 to be an obtuse angle exceeding 90°. An optical member 400A including protruding portions 410A each of which has an obtuse angle exceeding 90° as one of the internal angles thereof will be explained with reference to FIG. 7.

FIG. 7 is a schematic view illustrating a mechanism of change in the traveling direction of light that is caused by the optical member 400A and each protruding portion 410A. When the configuration illustrated in FIG. 7 is employed, the optical member 400 and the protruding portions 410 illustrated in FIG. 5 are replaced by the optical member 400A and the protruding portions 410. Transmitted light Lb5 illustrated in FIG. 7 is light generated by the incident light La entering the structure (for example, the liquid crystal panel 20 and the diffusion plate 30 illustrated in FIG. 2) of the image output part 10 illustrated in FIG. 2 that is arranged on the backlight 50 side of the optical member 40, like the transmitted light Lb3 explained with reference to FIG. 5. When the optical member 400A illustrated in FIG. 7 is employed, the optical member 40 illustrated in FIG. 2 is replaced by the optical member 400A. Thus, the incident light La2 enters the configuration of the image output part 10 that is arranged on the backlight 50 side of the optical member 400A, and then becomes the transmitted light Lb5 to enter the optical member 400A.

A plane Pd3 illustrated in FIG. 7 is the same as the plane Pd2 except that an angle formed by the plane Pd3 and the output axis Vz is an acute angle θ22. The surface of the optical member 400A on the backlight 50 side through which the transmitted light Lb5 enters is along the plane Pd3. A plane Pc3 illustrated in FIG. 7 is the same as the plane Pc2 except that an angle formed by the plane Pc3 and the output axis Vz is the acute angle θ22. The bases of the protruding portions 410A having the triangular shapes in the cross-sectional viewpoint coincide with the plane Pc3. The plane Pc3 is parallel to the plane Pd3 and coincides with the bases of the protruding portions 410A. Although not illustrated in the drawing, a straight line connecting vertices of the protruding portions 410A is parallel to the plane Pc3 and the plane Pd3. The vertices are vertices of the protruding portions 410A on the side facing the plane Pd3.

Although not illustrated in the drawing, the protruding portions 410A are aligned with no gap therebetween in the same manner as the protruding portions 41 and the protruding portions 410. It is assumed that a first protruding portion 410A and a second protruding portion 410A denote two adjacent protruding portions 410A, and a first vertex and a second vertex denote two vertices of each of the first and second protruding portions 410A, which are connected by the base thereof that coincides with the plane Pc3. In this case, the first vertex of the first protruding portions 410A coincides with the second vertex of the second protruding portions 410A. In other words, the surface along the plane Pc3 is not exposed to the concave mirror 60 side (refer to FIG. 1) of the optical member 400A.

When the optical member 400A illustrated in FIG. 7 is employed, the incident light La2 emitted from the backlight 50 becomes the transmitted light Lb5 and enters the optical member 400A from the plane Pd3 side. A difference between an acute angle θ421 and an acute angle θ422 depends on a relative refractive index between a material of each of the optical member 400A and the optical member forming the protruding portion 410A and the air outside the optical member 400A. The acute angle θ421 is an entering angle of the transmitted light Lb5 with respect to the optical member 400A, and the acute angle θ422 is an angle of the traveling direction of refracted light Lb6 entering the optical member 400A with respect to the plane Pd3.

The optical member 400A and each protruding portion 410A are continuous at a virtual bottom surface 413A of the protruding portion 410A that coincides with the plane Pc3, and the virtual bottom surface 413A is therefore not an interface. Each protruding portion 410A is made of the same material as that of the optical member 400A. No light refraction therefore occurs at the virtual bottom surface 413A.

The refracted light Lb6 that has passed through the optical member 400A and the triangular-shaped protruding portion 410A is output from an inclined surface 411A of the protruding portion 410A to the outside of the protruding portion 410A, thereby being output as output light Lc3. A difference between an acute angle θ423 and an acute angle θ424 depends on a relative refractive index between the material of each of the optical member 400A and the optical member forming the protruding portion 410A and the air outside the optical member 400A. The acute angle θ423 is a traveling angle of the refracted light Lb6 with respect to the inclined surface 411A, and the acute angle θ424 is an angle of the traveling direction of the output light Lc3 output to the outside of the protruding portion 410A with respect to the inclined surface 411A.

The output light Lc3 is along the output axis Vz in the same manner as the output light Lc2. Thus, an angle obtained by adding an angle θ420 and the acute angle θ424 together is the same as the acute angle θ22 formed by the plane Pc3 and the output axis Vz. The angle θ420 is an angle formed by the inclined surface 411A and the plane Pc3, and the acute angle θ424 is an angle of the output light Lc3 with respect to the inclined surface 411A. In other words, the material of each of the optical member 400A and the optical member forming the protruding portion 410A and the acute angle θ420 are determined such that the angle obtained by adding the angle θ420, which is formed by the inclined surface 411A and the plane Pc3, and the acute angle θ424 together is the same as the angle θ22. The acute angle θ422 between the refracted light Lb6 and the plane Pd3 is determined such that the refracted light Lb6 travels at the acute angle θ423 with respect to the inclined surface 411A. It is needless to say that the acute angle θ422 is determined in consideration of a relation between the acute angle θ422 and the acute angle θ421, that is, the relative refractive index between the material of each of the optical member 400A and the optical member forming the protruding portion 410A and the air outside the optical member 400A. In other words, the angle of the inclined surface 411A with respect to the output axis Vz and the angle of the plane Pd3 with respect to the output axis Vz are determined so as to satisfy a relation between the acute angle θ421, the acute angle θ422, the acute angle θ423, and the acute angle θ424, which are illustrated in FIG. 7.

Each protruding portion 410A has a triangular shape and has three surfaces. One surface 412A different from the inclined surface 411A and the virtual bottom surface 413A among the three surfaces is along the refracted light Lb6. The refracted light Lb6 does not therefore reach the one surface 412A in the protruding portion 410A theoretically. As illustrated in FIG. 7, the one surface 412A along the refracted light Lb6 and the plane Pc3 form an obtuse angle θ425 exceeding 90° in the protruding portion 410A. In other words, an angle formed by the one surface 412A and the plane Pc3 outside the protruding portion 410A is an acute angle θ426.

The acute angle θh=24.87°, the acute angle θk=45°, the acute angle θ11=65.13°, the acute angle θ22=45°, the acute angle θ420=26°, the acute angle θ421=69.87°, the acute angle θ422=76.63°, the acute angle θ423=50.63°, the acute angle θ424=19°, and the obtuse angle θ425=103.37° are examples of the respective angles. The angles are, however, not limited to them and are appropriately changed in accordance with various conditions such as the material forming the optical member 400A and the protruding portions 410A.

When attempting to form each protruding portion 410A as illustrated in FIG. 7 integrally with the optical member 400A, the degree of the technical difficulty in forming the protruding portion 410A increases compared to the case where the internal angle is equal to or smaller than 90° like the protruding portion 410 as explained with reference to FIG. 6. This is because the one surface 412A has an inversely tapered inclination with respect to the plane Pc3. In contrast, when the one surface 412 is at the right angle with respect to the plane Pc2 as illustrated in FIG. 6, each protruding portion 410 can be more easily formed integrally with the optical member 400. When the acute angle θ405 between the one surface 4b and the plane Pd in the optical member 40 is acute as illustrated in FIG. 4, each protruding portion 41 can be more easily formed integrally with the optical member 40.

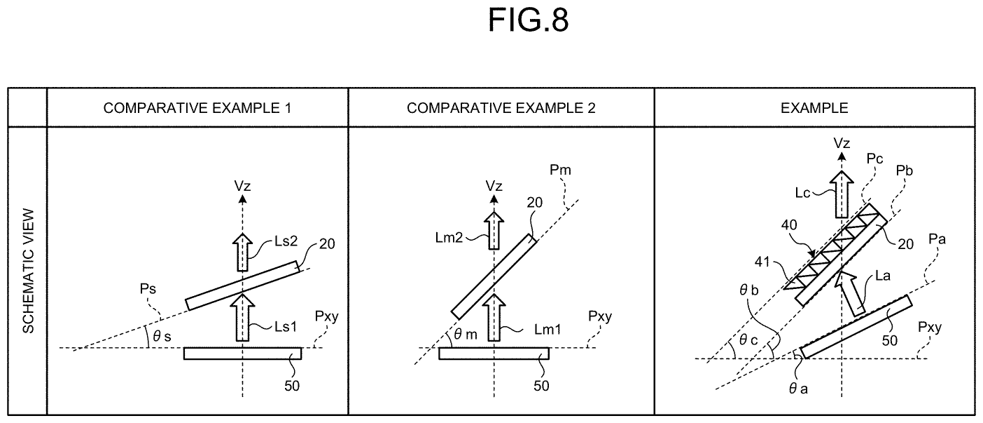

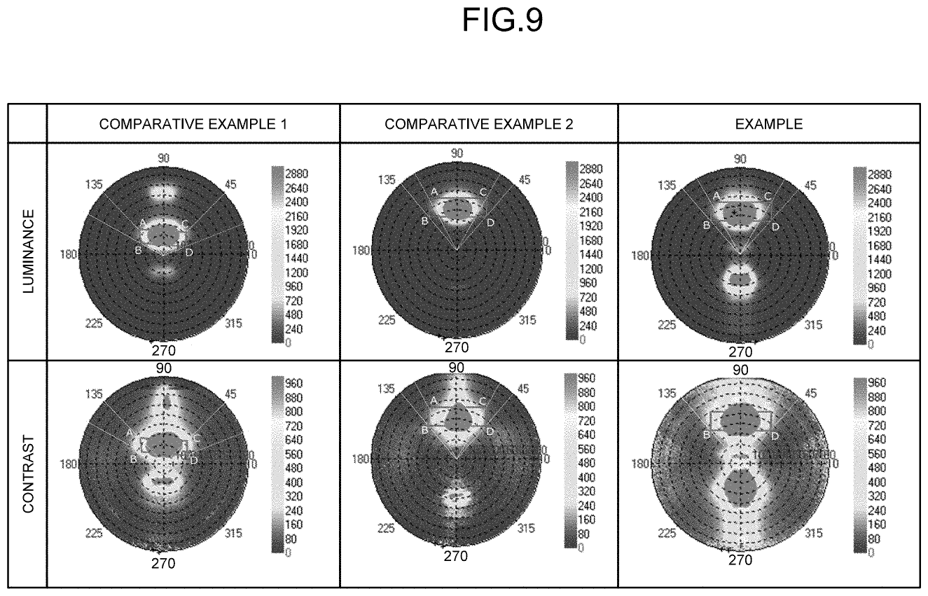

Next, unique effects provided by the configuration of the present disclosure will be explained with reference to FIG. 8 and FIG. 9.

FIG. 8 is a schematic view illustrating the configuration in each of Comparative Example 1, Comparative Example 2, and Example. The backlight 50 in Comparative Example 1 and Comparative Example 2 has a light output surface along the plane Pxy. The liquid crystal panel 20 in Comparative Example 1 is provided at an angle forming an acute angle θs with respect to the plane Pxy. The liquid crystal panel 20 in Comparative Example 2 is provided at an angle forming an acute angle θm with the plane Pxy. The acute angle θm is larger than the acute angle θs.

In Comparative Example 1 and Comparative Example 2, the optical member 40 is not provided. In Comparative Example 1, light Ls1 incident on the liquid crystal panel 20 and light Ls2 output from the liquid crystal panel 20 are along the output axis Vz. In Comparative Example 2, light Lm1 incident on the liquid crystal panel 20 and light Lm2 output from the liquid crystal panel 20 are along the output axis Vz.

The backlight 50 in Example is disposed such that the plane Pa along the output surface thereof on which the incident light La is incident forms the acute angle θa with the plane Pxy as explained with reference to FIG. 2. Thus, the incident light La travels in a direction intersecting with the output axis Vz in Example. The traveling direction of the incident light La is along the normal direction of the plane Pa.

In Example, the optical member 40 is provided along the liquid crystal panel 20 in the same manner as the above-mentioned image output part 10 illustrated in FIG. 2. Although the diffusion plate 30 in FIG. 2 is omitted in Example illustrated in FIG. 8, the diffusion plate 30 may be provided between the liquid crystal panel 20 and the optical member 40 in the same manner as the image output part 10 illustrated in FIG. 2. In Example, the plane Pb along the incident surface of the liquid crystal panel 20 on which the incident light La is incident, is provided so as to form the acute angle θb with the plane Pxy. In Example, the plane Pc along the output surface of the optical member 40 from which the output light Lc is output, is provided so as to form the acute angle θc with the plane Pxy. The incident light La incident on the liquid crystal panel 20 is output as the output light Lc along the output axis Vz by light refraction caused by the optical member 40 provided on the light output surface side of the liquid crystal panel 20. The acute angle θb in Example is the same as the acute angle θm in Comparative Example 2.

The user U can view the virtual image VG as if the virtual view VG has a stereoscopic effect in the depth direction by providing the liquid crystal panel 20 in the direction intersecting with the plane Pxy and the output axis Vz as in Comparative Example 1, Comparative Example 2, and Example. The stereoscopic effect can be made more remarkable by increasing the angle of the liquid crystal panel 20 with respect to the plane Pxy as in Comparative Example 2 relative to Comparative Example 1.

On the other hand, when the angle of the liquid crystal panel 20 with respect to the plane Pxy is further increased, the luminance of light forming the virtual image VG and the contrast of the virtual image VG tend to be lowered as in Comparative Example 2 relative to Comparative Example 1.

FIG. 9 is a view illustrating measurement results obtained by measuring the luminance of light forming the virtual image VG that is viewed by the user U and the contrast of the virtual image VG in each of Comparative Example 1, Comparative Example 2, and the Example. The user U views, as the virtual view VG, a range in a rectangle with four vertices A, B, C, and D in each of the luminance distribution views indicating the measurement results in FIG. 9.

As indicated by comparison between Comparative Example 1 and Comparative Example 2 in FIG. 9, a range of the luminance of equal to or higher than 2800 in the rectangle viewed as the virtual image VG by the user U is smaller in Comparative Example 2 than that in Comparative Example 1. A range of the contrast of equal to or higher than 960 in the rectangle viewed as the virtual image VG by the user U is smaller in Comparative Example 2 than that in Comparative Example 1. Thus, in Comparative Example 2, the luminance of light forming the virtual image VG and the contrast of the virtual image VG are lowered because the angle of the liquid crystal panel 20 with respect to the plane Pxy is increased to be larger than that in Comparative Example 1.

In contrast, Example differs from Comparative Example 1 and Comparative Example 2 in that the output surface of the backlight 50 from which the incident light La is output is inclined with respect to the plane Pxy, whereby the angle between the incident surface of the liquid crystal panel 20 on which the incident light La is incident and the output surface of the backlight 50 from which the incident light La is output, is set to an angle obtained by subtracting the acute angle θa from the acute angle θb. That is to say, in Example, the angle between the incident surface of the liquid crystal panel 20 on which the incident light La is incident and the output surface of the backlight 50 from which the incident light La is output, can be made smaller than the angle θm between the incident surface of the liquid crystal panel 20 on which the incident light Lm1 is incident and the output surface of the backlight 50 from which the incident light Lm1 is output in Comparative Example 2. In Example, provision of the optical member 40 enables the incident light La incident on the liquid crystal panel 20 in a direction intersecting with the output axis Vz to be output to the concave mirror 60 as the output light Lc along the output axis Vz. The range of the luminance of equal to or higher than 2800 in the rectangle viewed as the virtual image VG by the user U can be made wider in Example than that in Comparative Example 2. The range of the contrast of equal to or higher than 960 in the rectangle viewed as the virtual image VG by the user U can be made wider in Example than that in Comparative Example 2. According to Example, provision of the liquid crystal panel 20 at the same angle as that in Comparative Example 2 enables the above-mentioned stereoscopic effect to be made more remarkable than that in Comparative Example 1, and output of the virtual image VG with higher luminance and higher contrast than those in Comparative Example 2 can be provided.

Although the diffusion plate 30 is provided between the liquid crystal panel 20 and the optical member 40 in the image output part 10 illustrated in FIG. 2, the diffusion plate 30 may be arranged on the output side of the optical member 40 from which the output light Lc is output. That is to say, the optical member 40 (or the optical member 400 or the optical member 400A) may be arranged between the liquid crystal panel 20 and the diffusion plate 30. When the diffusion plate 30 is provided between the liquid crystal panel 20 and the optical member 40, the luminance of light that is viewed as the virtual image VG is easily increased.

In general HUDs, the diffusion plate 30 is provided between the backlight 50 and the liquid crystal panel 20. Specifically, the diffusion plate 30 is provided on the light output surface of the backlight 50. In the embodiment, the diffusion plate 30 is provided between the liquid crystal panel 20 and the optical member 40, and the diffusion plate 30 is not provided between the backlight 50 and the liquid crystal panel 20, as described above.

As explained above, according to the present disclosure, the HUD 1 includes the light source (backlight 50) configured to emit light, the liquid crystal panel (liquid crystal panel 20) configured to transmit light from the light source to project an image, and the optical member (optical member 40, optical member 400, or optical member 400A) configured to refract light that has passed through the liquid crystal panel. The light output surface of the light source intersects, at a first acute angle (acute angle θ1), with the optical axis of output light that has passed through the optical member. The plate surface of the liquid crystal panel intersects with the optical axis of the output light at a second acute angle (acute angle θ2), and the second acute angle is smaller than the first acute angle.

With this configuration, the stereoscopic effect of the virtual image (virtual image VG) can be provided by inclining the liquid crystal panel, and the luminance of light of the virtual image VG can be made higher than that in the case where no optical member (optical member 40) is provided, as explained with reference to FIG. 9. According to the present disclosure, both the stereoscopic effect of the virtual image and the luminance of the virtual image can thereby be achieved.

In addition, the diffusion plate (diffusion plate 30) provided between the liquid crystal panel (liquid crystal panel 20) and the optical member (optical member 40) and configured to diffuse light is further included. This configuration can prevent moire from being generated in the virtual image VG more reliably.

The optical member (optical member 40) is provided with, on the side facing the liquid crystal panel (liquid crystal panel 20), the protruding portions (protruding portions 41) having the inclined surfaces (inclined surfaces 4a) inclined with respect to the plate surface of the liquid crystal panel. The protruding portions can further increase the angle of refraction of light by the optical member. Thus, the stereoscopic effect of the virtual image VG can be made more remarkable.

The surface of the optical member (optical member 40) on the side opposite to the protruding direction of the protruding portions (protruding portions 41) is parallel to the plate surface of the liquid crystal panel. This configuration allows the degree of light refraction by the optical member 40 to be determined by the angle of the inclined surfaces (inclined surfaces 4a) of the protruding portions (protruding portions 41), thereby further facilitating the design of the optical member.

Other action effects provided by the modes described in the above-mentioned embodiment that are obvious from description of the present specification or at which those skilled in the art can appropriately arrive should naturally be interpreted to be provided by the present disclosure.

What is claimed is:

1. A head-up display comprising:
a light source configured to emit light;
a liquid crystal panel configured to transmit light from the light source to project an image; and
an optical member configured to refract light that has passed through the liquid crystal panel, wherein
a light output surface of the light source intersects with an optical axis of output light at a first acute angle, the output light having passed through the optical member,
a plate surface of the liquid crystal panel intersects with the optical axis of the output light at a second acute angle, and
the second acute angle is smaller than the first acute angle.

2. The head-up display according to claim 1, further comprising a diffusion plate provided between the liquid crystal panel and the optical member and configured to diffuse light.

3. The head-up display according to claim 1, wherein the optical member is provided with, on a side facing the liquid crystal panel, a plurality of protruding portions having inclined surfaces inclined with respect to the plate surface of the liquid crystal panel.

4. The head-up display according to claim 3, wherein a surface of the optical member on a side opposite to a protruding direction of the protruding portions is parallel to the plate surface of the liquid crystal panel.

5. A display device comprising:
a light source configured to emit light;
a liquid crystal panel configured to transmit light from the light source to project an image; and
an optical member configured to refract light that has passed through the liquid crystal panel, wherein
a light output surface of the light source and a plate surface of the liquid crystal panel are inclined at different angles with respect to an optical axis of output light that has passed through the optical member.

6. The display device according to claim 5, further comprising a diffusion plate provided between the liquid crystal panel and the optical member and configured to diffuse light.

7. The display device according to claim 5, wherein the optical member is provided with, on a side facing the liquid crystal panel, a plurality of protruding portions having inclined surfaces inclined with respect to the plate surface of the liquid crystal panel.

8. The display device according to claim 7, wherein a surface of the optical member on a side opposite to a protruding direction of the protruding portions is parallel to the plate surface of the liquid crystal panel.

9. The display device according to claim 5, wherein the optical member has a surface parallel to the plate surface of the liquid crystal panel.

10. The display device according to claim 9, wherein the optical member has the parallel surface on a side facing the liquid crystal panel.

11. The display device according to claim 9, wherein the optical member has the parallel surface on a side opposite to a side facing the liquid crystal panel.
